(19) United States
(12) Patent Application Publication
(10) Pub. No.: US 2024/0403386 A1
(43) Pub. Date: Dec. 5, 2024

(54) ANOMALY DETECTION METHOD AND SYSTEM

(71) Applicants: SAMSUNG SDS CO, LTD., Seoul (KR); UIF (University Industry Foundation), Yonsei University, Seoul (KR)

(72) Inventors: Hak Soo LIM, Seoul (KR); Min-Jung KIM, Seoul (KR); Se Won PARK, Seoul (KR); No Seong PARK, Seoul (KR)

(73) Assignees: SAMSUNG SDS CO, LTD., Seoul (KR); UIF (University Industry Foundation), Yonsei University, Seoul (KR)

(21) Appl. No.: 18/678,724

(22) Filed: May 30, 2024

(30) Foreign Application Priority Data
May 30, 2023 (KR) 10-2023-0069079

(51) Int. Cl. G06F 18/15; G06F 123/02

(52) U.S. Cl. CPC G06F 18/15; G06F 2123/02; G06F 2218/04

(57) ABSTRACT

A method for an anomaly detection is provided. The method may include acquiring a score predictor trained using normal time-series data, wherein the score predictor is a deep learning model configured to output a conditional score for previous time-series data and the conditional score represents a gradient of data density, extracting data for a specific time and data segments corresponding to a period before the specific time from target time-series data, and predicting a conditional score for the data segments through the trained score predictor and conducting an anomaly determination for the data for the specific time using the predicted conditional score.

### CROSS-REFERENCE TO RELATED APPLICATION

This application claims priority from Korean Patent Application No. 10-2023-0069079 filed on May 30, 2023, in the Korean Intellectual Property Office, and all the benefits accruing therefrom under 35 U.S.C. 119, the contents of which in its entirety are herein incorporated by reference.

### BACKGROUND

### 1. Field

The present disclosure relates to an anomaly detection method and system, and more particularly, to an anomaly detection method and system for detecting anomalies in time-series data using a generative deep learning model.

### 2. Description of the Related Art

Deep learning technology has been introduced and utilized across various fields due to its inherent scalability and flexibility. Recently, deep learning technology has gained more attention as it demonstrates performances that significantly surpass those of existing methods.

One of the fields where deep learning technology has been most actively adopted is the anomaly detection field. Tasks in the anomaly detection field are a type of classification task that differentiates given data as an anomaly or normality. Since such classification task is where deep learning models can excel, deep learning technology is being actively introduced in the anomaly detection field.

Meanwhile, there are roughly two biggest obstacles to the adoption of deep learning technology in the anomaly detection field. The first is the difficulty in securing sufficient abnormal data for training deep learning models, and the second is that abnormal data, unlike normal data, have their unique characteristics, making it difficult for deep learning models to accurately learn the patterns of abnormal data. Consequently, recent research has been actively conducted on methods for performing anomaly detection using only normal data.

### SUMMARY

Aspects of the present disclosure provide a method and system capable of accurately detecting anomalies in time-series data using a generative deep learning model.

Aspects of the present disclosure also provide a method and system capable of accurately calculating an anomaly score for time-series data using a generative deep learning mode.

Aspects of the present disclosure also provide a method for reducing the cost invested in acquiring abnormal time-series data.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to some embodiments of the present disclosure, there is provided an anomaly detection method performed by at least one computing device. The method may include acquiring a score predictor trained using normal time-series data, wherein the score predictor is a deep learning model configured to output a conditional score for previous time-series data and the conditional score represents a gradient of data density, extracting data for a specific time and data segments corresponding to a period before the specific time from target time-series data, and predicting a conditional score for the data segments through the trained score predictor and conducting an anomaly determination for the data for the specific time using the predicted conditional score.

In some embodiments, the score predictor may include a convolution layer that performs a one-dimensional (1D) convolution operation.

In some embodiments, the score predictor may be configured based on a neural network with a U-Net architecture.

In some embodiments, conducting the anomaly determination for the data for the specific time, may include: extracting noise samples from a prior distribution, predicting a conditional score of the noise samples for the data segments by inputting the noise samples and the data segments to the trained score predictor, generating synthetic data corresponding to the specific time by updating the noise samples using the predicted conditional score, and determining the data for the specific time as being abnormal when a reconstruction loss between the data for the specific time and the synthetic data exceeds a threshold.

In some embodiments, a plurality of synthetic data may be generated from different noise samples extracted from the prior distribution, and the determining the data for the specific time as being abnormal, may include: aggregating reconstruction losses for the plurality of synthetic data, and determining the data for the specific time as being abnormal when the aggregated reconstruction loss exceeds the threshold.

In some embodiments, conducting the anomaly determination for the data for the specific time, may include: determining an Ordinary Differential Equation (ODE) corresponding to a Stochastic Differential Equation (SDE) used in a synthetic data generation process, wherein the SDE is an equation using the predicted conditional score as a coefficient, calculating a conditional probability of the data for the specific time for the data segments using the ODE, and determining the data for the specific time as being abnormal when the calculated conditional probability is less than a threshold.

In some embodiments, conducting the anomaly determination for the data for the specific time, may include determining the data for the specific time as being normal when a magnitude of the predicted conditional score is less than or equal to a threshold.

In some embodiments, conducting the anomaly determination for the data for the specific time, may include: calculating a loss for the predicted conditional score using a loss function used in training the score predictor, and determining the data for the specific time as being abnormal when the calculated loss exceeds a threshold.

According to some embodiments of the present disclosure, there is provided an anomaly detection method performed by at least one computing device. The method may include acquiring a score predictor trained using normal time-series data, wherein the score predictor is a deep learning model configured to output a conditional score for previous time-series data and the conditional score represents a gradient of data density, extracting data for a specific time and first data segments corresponding to a period before the specific time from target time-series data, generating second data segments by adjusting the first data segments through the trained score predictor, and predicting a conditional score for the second data segments through the trained score predictor and conducting an anomaly determination for the data for the specific time using the predicted conditional score.

In some embodiments, generating the second data segments, may include: generating noisy data segments by adding noise to the first data segments, predicting a score of the noisy data segments by inputting the noisy data segments to the trained score predictor, and generating the second data segments by updating the noisy data segments using the predicted score.

In some embodiments, the score predictor may be trained using a first loss function related to the conditional score for the previous time-series data and a second loss function related to a general score that does not condition on the previous time-series data, and the predicted score may be a general score calculated in a state where previous time-series data of the noisy data segments is not input to the trained score predictor.

In some embodiments, conducting the anomaly determination for the data for the specific time, may include: extracting noise samples from a prior distribution, predicting a conditional score of the noise samples for the second data segments by inputting the noise samples and the second data segments to the trained score predictor, generating synthetic data corresponding to the specific time by updating the noise samples using the predicted conditional score, and determining the data for the specific time as being abnormal when a reconstruction loss between the data for the specific time and the synthetic data exceeds a threshold.

In some embodiments, conducting the anomaly determination for the data for the specific time, may include: determining an Ordinary Differential Equation (ODE) corresponding to a Stochastic Differential Equation (SDE) used in a synthetic data generation process, wherein the SDE is an equation using the predicted conditional score as a coefficient, calculating a conditional probability of the data for the specific time for the second data segments using the ODE, and determining the data for the specific time as being abnormal when the calculated conditional probability is less than a threshold.

In some embodiments, conducting the anomaly determination for the data for the specific time, may include determining the data for the specific time as being normal when a magnitude of the predicted conditional score is less than or equal to a threshold.

In some embodiments, conducting the anomaly determination for the data for the specific time, may include calculating a loss for the predicted conditional score using a loss function used in training the score predictor, and determining the data for the specific time as being abnormal when the calculated loss exceeds a threshold.

According to some embodiments of the present disclosure, there is a provided anomaly detection system. The system may include at least one processor and a memory storing a computer program executed by the at least one processor, wherein the computer program may include instructions for performing operations of: acquiring a score predictor trained using normal time-series data, wherein the score predictor is a deep learning model configured to output a conditional score for previous time-series data and the conditional score represents a gradient of data density, extracting data for a specific time and data segments corresponding to a period before the specific time from target time-series data, and predicting a conditional score for the data segments through the trained score predictor and conducting an anomaly determination for the data for the specific time using the predicted conditional score.

According to the aforementioned and other embodiments of the present disclosure, anomalies are detected in target time-series data using a score predictor trained with normal time-series data, and abnormal time-series data is not required for training the score predictor. As a result, the cost invested in acquiring abnormal time-series data can be significantly reduced.

Moreover, both the performance of the score predictor and the quality of synthetic time-series data can be greatly improved by configuring the score predictor to predict a conditional score for previous time-series data. That is, the performance of the score predictor can be greatly enhanced by configuring and training the score predictor to consider the characteristics of time-series data (e.g., the relationship with data for previous points in time). Furthermore, as the quality of the synthetic time-series data improves, the accuracy of anomaly detection can also be enhanced. For example, since the accuracy of anomaly detection based on reconstruction loss depends on the quality of the synthetic data, the accuracy of anomaly detection can also be improved as high-quality synthetic time-series data (e.g., synthetic data for a specific time) is generated.

In addition, the accuracy of anomaly detection for time-series data can be further improved by using conditional scores, conditional probabilities, the magnitude of the conditional scores, and loss regarding the conditional scores as anomaly scores.

Additionally, the accuracy of anomaly detection can be further enhanced by adjusting time-series data prior to a specific time to be closer to normal data and using the conditional score for the adjusted time-series data to conduct an anomaly determination for data for the specific time.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is an exemplary diagram for explaining the operation of an anomaly detection system according to some embodiments of the present disclosure;

FIGS. 2 and 3 are exemplary diagrams for explaining the operating principles of a score-based generative model according to some embodiments of the present disclosure and the concept of a score;

FIG. 4 is an exemplary flowchart illustrating an anomaly detection method according to some embodiments of the present disclosure;

FIG. 5 is an exemplary diagram for explaining how to extract data segments according to some embodiments of the present disclosure;

FIG. 6 is an exemplary diagram for explaining a score predictor according to some embodiments of the present disclosure;

FIG. 7 is an exemplary diagram for explaining the structure of, and a training method for, the score predictor according to some embodiments of the present disclosure;

FIG. 8 is an exemplary flowchart illustrating how to conduct an anomaly determination based on a reconstruction loss according to some embodiments of the present disclosure;

FIGS. 9 and 10 are exemplary diagrams for explaining how to conduct an anomaly determination based on a reconstruction loss according to some embodiments of the present disclosure;

FIG. 11 is an exemplary flowchart illustrating an anomaly detection method according to some embodiments of the present disclosure;

FIG. 12 is an exemplary diagram for explaining a training method for a score predictor according to some embodiments of the present disclosure;

FIG. 13 is an exemplary conceptual diagram for explaining the reasons for adjusting data segments to be closer to normal data according to some embodiments of the present disclosure;

FIGS. 14 and 15 are exemplary diagrams for explaining how to adjust data segments according to some embodiments of the present disclosure; and

FIG. 16 is an exemplary hardware configuration view of an exemplary computing device that can implement the anomaly detection system according to some embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), may be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Embodiments of the present disclosure will be described with reference to the attached drawings.

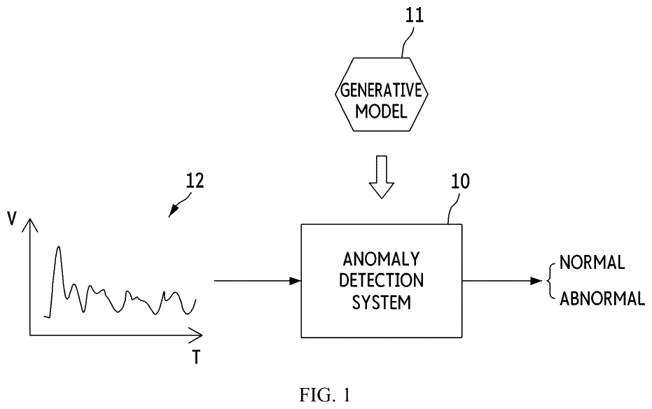

FIG. 1 is an exemplary diagram for explaining the operation of an anomaly detection system 10 according to some embodiments of the present disclosure.

Referring to FIG. 1, the anomaly detection system 10 is a computing device/system capable of detecting anomalies in time-series data 12. Specifically, the anomaly detection system 10 may detect anomalies in the time-series data 12 using a score-based generative model 11. For convenience, the anomaly detection system 10 will hereinafter be referred to as the detection system 10.

The term “anomaly” may also be referred to as “abnormality,” “outlier,” “abnormal sign,” etc., and may be understood as encompassing the concepts of all these terms.

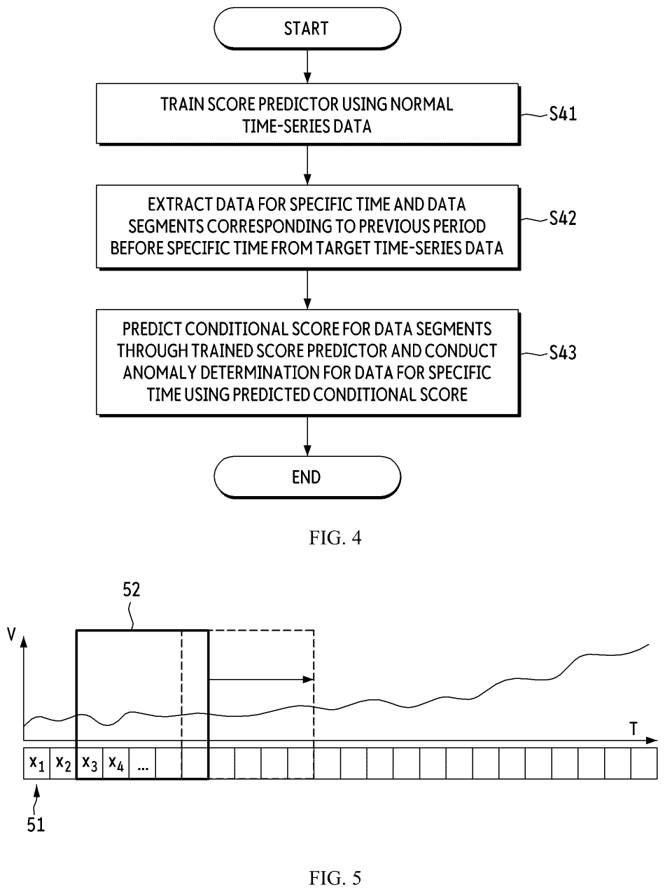

More specifically, the detection system 10 may train a score predictor (or score estimator) that forms the score-based generative model 11, using normal time-series data. The detection system 10 may detect anomalies in the time-series data 12 using the trained score predictor. For example, the detection system 10 may generate synthetic data corresponding to a specific point in time in the time-series data 12 using the trained score predictor. Then, the detection system 10 may conduct an anomaly determination for actual/original data for the specific time by using reconstruction loss between the actual/original data and the synthetic data as an anomaly score. Additionally, the detection system 10 may calculate various types of anomaly scores using the trained score predictor, which will be described later in detail with reference to FIGS. 4 through 11.

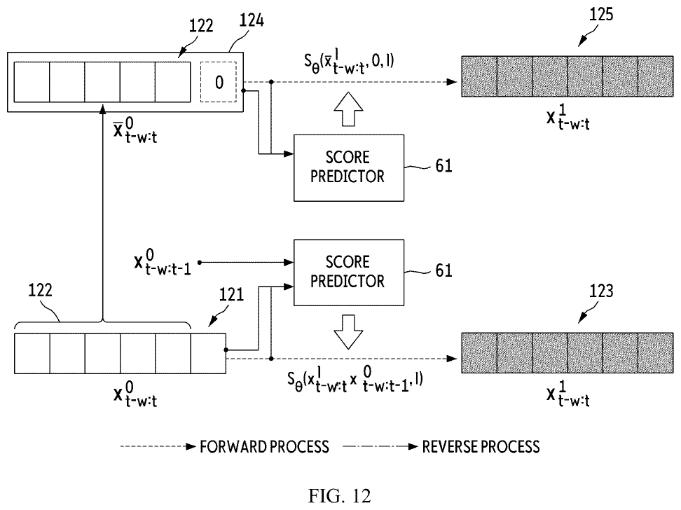

Furthermore, the detection system 10 may adjust data segments of the time-series data 12 to be closer to normal data using the score predictor trained with normal time-series data. The detection system 10 may accurately calculate anomaly scores using the adjusted data segments, which will be described later in detail with reference to FIGS. 12 through 15.

The detection system 10 may be implemented as at least one computing device. For example, all functions of the detection system 10 may be implemented in one computing device, or first and second functions of the detection system 10 may be implemented in first and second computing devices, respectively. Alternatively, a specific function of the detection system 10 may be implemented across multiple computing devices.

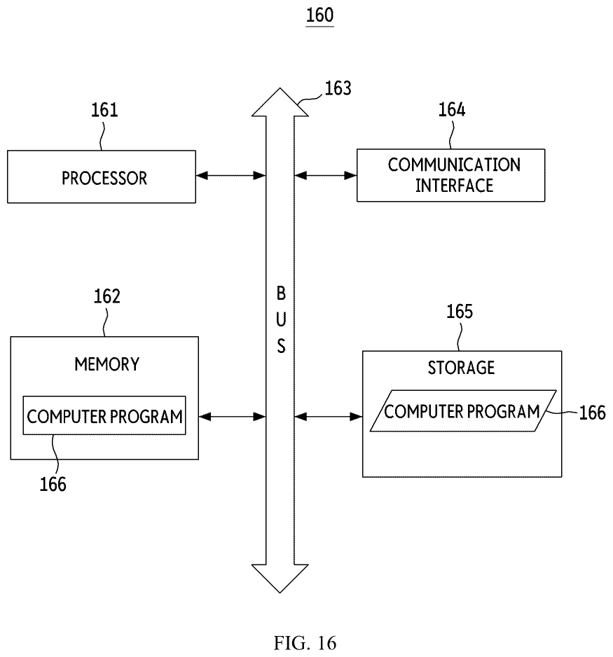

The term “computing device” may encompass any type of device equipped with computing functionalities, and an exemplary computing device will be described later with reference to FIG. 16.

As a computing device is an assembly where various components (e.g., a memory, a processor, etc.) interact, it may sometimes be referred to as a computing system, which may also encompass the concept of an assembly where multiple computing devices interact.

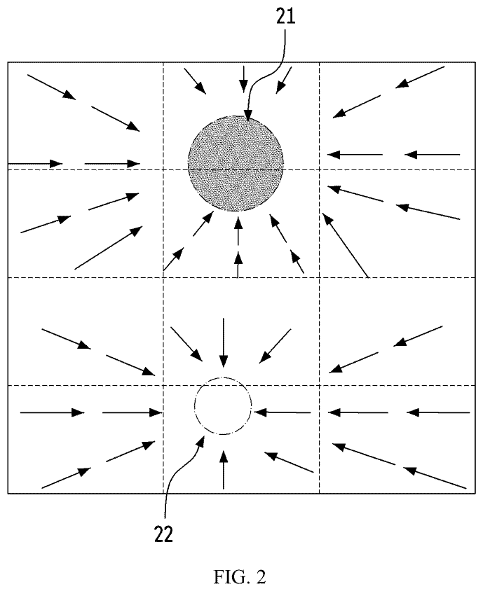

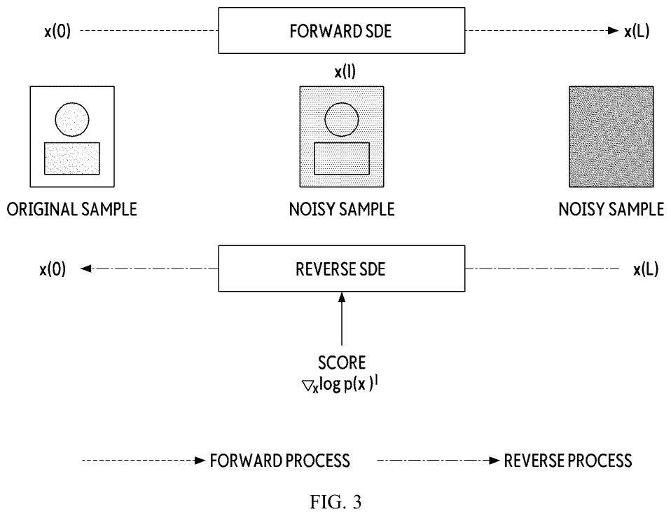

The operation of the detection system 10 has been described so far with reference to FIG. 1. The operating principles of a score-based generative model and the concept of a score that can be referenced in some embodiments of the present disclosure will hereinafter be described with reference to FIGS. 2 and 3.

A score-based generative model refers to a model capable of generating synthetic samples (or data) using a score, which may be values indicating the gradients (e.g., gradient vectors) of data density. For example, a score may be calculated by differentiating the log probability density function (or log likelihood) of data (refer to the formula in FIG. 3).

The reason for generating synthetic samples (or data) using a score is as follows. Since the direction of gradient vectors for data density indicates the direction where the data density increases, using a score allows for the generation (sampling) of synthetic samples (or data) in a high-density area (i.e., a score can easily move sampling points to a high-density area), and the generated synthetic samples (or data) may have similar characteristics to actual samples (or data) because a high-density area in a data space refer to an area where the actual samples (or data) are concentrated. For example, referring to FIG. 2, which illustrates areas 21 and 22 of relatively high densities in the data space and scores (indicated by arrows), the areas 21 and 22 may be reached by moving along the directions of the scores from each particular point.

In the technical field of the present disclosure, the term “synthetic sample” may be interchangeably used with “synthetic sample,” “fake sample,” “virtual sample,” and “sample” may also be used interchangeably with “data.”

In the score-based generative model, the prediction of a score may be performed by a score predictor with learnable parameters. The score predictor, which is a deep learning model that predicts the score of input data, may be implemented as, for example, various forms/structures of neural networks.

A typical score predictor may be trained using samples from an original (or actual) dataset, and more specifically, using noisy samples generated from the samples of the original dataset. Here, the noisy samples may refer to samples obtained by adding noise (e.g., Gaussian noise) with a prior (or already-known) distribution (e.g., a normal distribution) to original samples. Notably, if noise is continuously added to original samples, the original samples may become almost identical to noise samples, and thus, conceptually, the noisy samples may encompass noise samples. The term “noisy sample” may be interchangeably used with “transformed sample” or “perturbed sample.”

Adding noise to original samples may be understood as means for preventing the prediction accuracy of a score from dropping in a low-density area and for simplifying the loss function of the score predictor to facilitate the training of the score predictor. In other words, it may be understood that since the correct score (or distribution) of original samples is unknown, training is performed by indirectly predicting the score of noisy samples with noise with a prior distribution added thereto. An example of this type of technique is a denoising score matching method. The denoising score matching method is already well known to one of ordinary skill in the art to which the present disclosure pertains, and thus, a detailed explanation thereof will be omitted.

The addition of noise to original samples may be modeled either continuously or discretely.

For example, referring to FIG. 3, a noise addition process may be modeled in a continuous form using a Stochastic Differential Equation (SDE) (“forward process”). In FIG. 3, x(1) denotes a noisy sample at a time step (or point) 1, and x(0) denotes an original sample. The original sample x(0) may gradually become noisier through the addition of noise, eventually transforming into a noisy (or noise) sample with a prior distribution x(L). Various noisy samples produced up to a time step L may be utilized for training the score predictor. SDEs used in the score-based generative model may be already well known to one of ordinary skill in the art to which the present disclosure pertains, and thus, a detailed description thereof will be omitted.

Alternatively, the noise addition process may be modeled discretely as the process of adding noise of designated scales in incremental (or gradual) steps.

The generation of synthetic samples using the score predictor may proceed as the inverse of the noise addition process (i.e., as a noise removal process). For example, referring again to FIG. 3, a synthetic sample generation process may be understood as gradually removing noise from the noise (or noisy) sample with the prior distribution x(L) using a score predicted by the score predictor, updating the noise sample to have the distribution of the original sample (“reverse process”). For this, a technique such as Markov Chain Monte Carlo (MCMC), the Euler-Maruyama solver, the predictor-corrector method, etc., may be used, but the present disclosure is not limited thereto. In other words, it may be understood that the synthetic sample is generated by repeatedly performing the noise removal process to update the noisy sample to a high-density area using a predicted score.

The operating principles of, and the training method for, the score-based generative model may be already well known to one of ordinary skill in the art to which the present disclosure pertains, and thus, detailed descriptions thereof will be omitted. For more information on the score-based generative model and SDEs, refer to the paper titled “Score-Based Generative Modeling through Stochastic Differential Equations.” For ease of understanding, the noise addition and removal processes will hereinafter be described as being modeled using the SDE scheme.

The operating principles of the score-based generative model and the concept of a score have been explained so far with reference to FIGS. 2 and 3. Various methods that can be performed in the detection system 10 will hereinafter be described with reference to FIG. 4 and the subsequent drawings. For clarity, reference numbers will be omitted when not directly referencing the drawings.

For ease of understanding, it is assumed that all steps/actions of the methods that will hereinafter be described are performed by the detection system 10. If the subject of a specific step/action is omitted, it may be understood that the specific step/action is performed by the detection system 10. However, in an actual environment, some steps/actions of the methods that will hereinafter be described may be performed by different computing devices. For example, the training of the score predictor may be conducted on a separate computing device.

FIG. 4 is an exemplary flowchart illustrating an anomaly detection method according to some embodiments of the present disclosure. However, the embodiment of FIG. 4 is merely exemplary for achieving the objectives of the present disclosure, and some steps may be added or omitted, as necessary.

Referring to FIG. 4, the anomaly detection method may begin with step S41, which is the step of training a score predictor using normal time-series data. Here, the normal time-series data refers to training data that has been classified as normal. Additionally, as mentioned earlier, the score predictor is a deep learning model configured to predict a score for input data. An exemplary structure of, and an exemplary training method for the score predictor will be described later in detail.

Specifically, the detection system 10 may extract multiple normal data segments from the normal time-series data and may train the score predictor using the extracted normal data segments. Here, the term “data segment” refers to time-series data corresponding to a specific time interval. A data segment may include data for one or more points in time (e.g., data (or values) for a specific time), and the data for the specific time may be multidimensional data.

For example, referring to FIG. 5, the detection system 10 may extract multiple normal data segments from normal time-series data 51, as indicated by a window 52, using a sliding window technique. Here, the extracted data segments are not necessarily time-series data of the same size as the window 52. This extraction method may also be applied to target time-series data. Parameters such as the stride and size of the window 52 may vary.

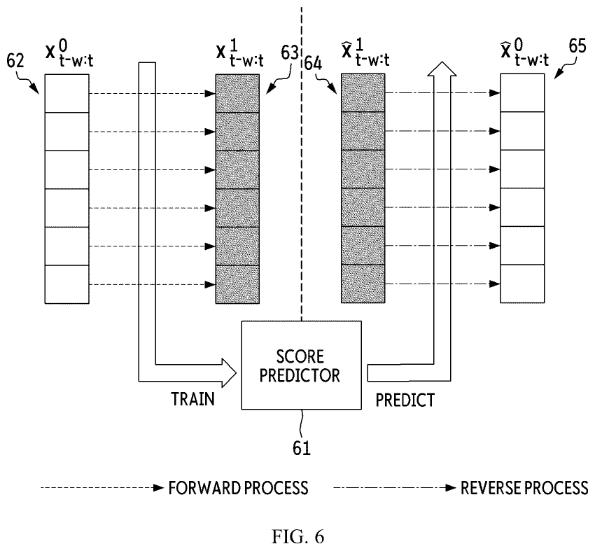

For ease of understanding, the structure of, and a training method for, a score predictor according to some embodiments of the present disclosure will hereinafter be described with reference to FIGS. 6 through 8.

FIG. 6 is an exemplary diagram for explaining a score predictor 61 according to some embodiments of the present disclosure. FIG. 6 assumes that the size of the window 52 and data segments 62 is (w+1) (where w is an integer greater than or equal to 0).

Referring to FIG. 6, the score predictor 61 may be trained through a forward process, and in a reverse process, a predicted score provided by the trained score predictor 61 may be used to generate synthetic data segments 65. Here, the forward process may refer to a forward SDE-based noise addition process, while the reverse process may refer to a reverse SDE-based noise removal process and a synthetic data generation process. For convenience, the synthetic data segments 65 may be abbreviated to synthetic data 65.

In the forward process, the data segments 62 may be gradually noised, as indicated by reference numeral 63, and multiple noisy data segments may be generated, which may then be utilized to train the score predictor 61.

In the reverse process, noise data segments 64 are gradually updated (i.e., noise is removed from the noise data segments 64) using a predicted score provided by the trained score predictor 61, resulting in the generation of the synthetic data segments 65. Since the noise data segments 64 are samples extracted from the prior distribution, the noise data segments 64 may also be referred to as noise samples 64.

In FIG. 6, x_{t-w:t} represents time-series data (or a data segment) for a period from a time (t−w) to a time t, the superscript 0 on the right of x (i.e., 1=0) indicates a state with no added noise (i.e., original data), and the superscript 1 on the right of x (i.e., 1=1) indicates a state with noise added up to a predetermined maximum number of time steps (i.e., noise data). Additionally, the symbol \hat{ } above x indicates that the data x is synthetic data.

The score predictor 61 may be implemented as various types of neural networks. For instance, the score predictor 61 may be based on a Convolutional Neural Network (CNN), an Artificial Neural Network (ANN), etc., but the present disclosure is not limited thereto.

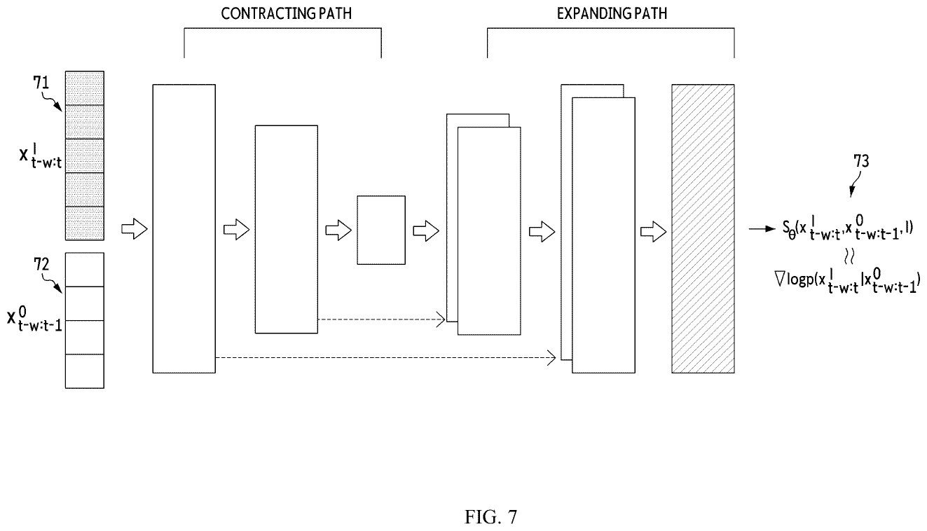

The structure of the score predictor 61 is as illustrated in FIG. 7.

Referring to FIG. 7, in some embodiments, the score predictor 61 may be configured as a neural network with a U-Net architecture, but the present disclosure is not limited thereto. U-Net is a U-shaped neural network featuring a contracting path (or encoder) and an expanding path (or decoder), connected by skip-connections (indicated by dashed arrows) between the contracting path (or encoder) and the expanding path (or decoder). The structure and operating principles of U-Net are already well known to one of ordinary skill in the art to which the present disclosure pertains, and thus, detailed descriptions thereof will be omitted.

In some embodiments, at least some layers that form the contracting path (or encoder) and/or the expanding path (or decoder) of the score predictor 61 contracting path (or encoder) and/or expanding path (or decoder) may be configured as convolutional layers performing a one-dimensional (1D) convolution operation. Here, the 1D convolution operation may be used because it is more suitable than a two-dimensional (2D) convolution operation for analyzing time-series data.

Additionally, as illustrated, the score predictor 61 may be configured to output a conditional score 73 for previous time-series data segments 72. In this manner, the score predictor 61 may predict a score in consideration of the characteristics of time-series data, such as the relationship with data for previous times, and as a result, the performance of the score predictor 61 and the quality of synthetic time-series data may be considerably enhanced.

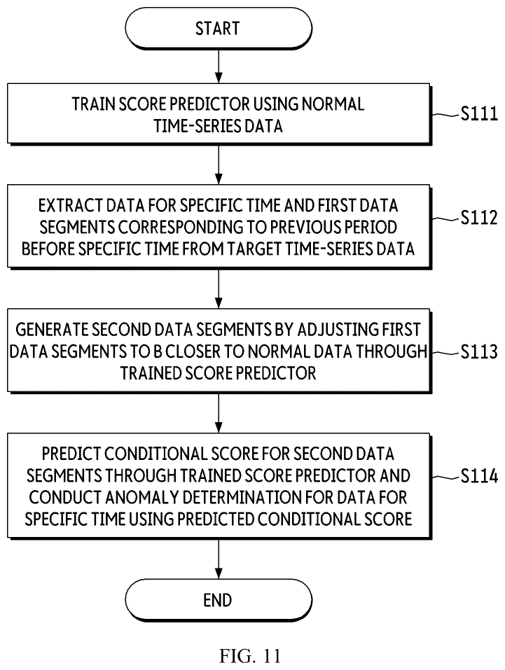

FIG. 7 illustrates an example where the score predictor 61 is configured to receive data segments 71 (hereinafter, the first data segments 71) containing data for the time t and data segments 72 (hereinafter, the second data segments 72) corresponding to a previous time period to the time t and output the conditional score 73 for the first data segments 71 based on the second data segments 72, but the present disclosure is not limited thereto. Alternatively, in some embodiments, the score predictor 61 may be configured to receive only the second data segments 72 and the data for the time t to output the conditional score 73. Unless otherwise stated, first data segments and second data segments are assumed to refer to the first data segments 71 and the second data segments 72, respectively (but their usage may change, starting from the description of FIG. 11).

Additionally, FIG. 7 illustrates an example where the second data segments 72 are time-series data for a period from the time (t−w) to a time (t−1) (i.e., with a segment size of w), but the present disclosure is not limited thereto. For ease of understanding, the score predictor 61 will hereinafter be described as receiving data as exemplified in FIG. 7.

The first data segments 71, which are targets for score prediction, may represent noisy data at the time step 1, whereas the second data segments 72 may represent data without added noise.

In FIG. 7, “Se” denotes the score predictor 61, the superscript 1 on the right of x indicates a time step or variable, and the symbol V denotes gradient.

The detection system 10 may train the score predictor 61, as exemplified in FIG. 7, using multiple normal data segments extracted from normal time-series data. Specifically, the detection system 10 may create the first data segments 71 through the forward process, which adds noise to the normal data segments according to a predefined distribution. As mentioned earlier, the noise addition process may be repeated until a predefined condition is met (e.g., if the maximum number of time steps is set to 100, the noise addition process may be repeated 100 times), and may be based on a forward SDE indicated by Equation 1 below. Referring to Equation 1, f and g denote functions that may be defined in advance in various manners, and w denotes a Standard Wiener process and corresponds to a term that represents randomness.

$${dx}_{t - w : t}^{l} = f ( {x}_{t - w : t}^{l} , l ) dl + g ( l ) dw , l ∈ [ 0 , 1 ] \qquad [ Equation 1 ]$$

For additional details on the forward SDE indicated by Equation 1 (e.g., “f,” “g,” and “w”), refer to the paper titled “Score-Based Generative Modeling through Stochastic Differential Equations”).

Thereafter, the detection system 10 may extract the second data segments 72 from the normal data segments and may input both the first data segments 71 and the second data segments 72 to the score predictor 61 to predict the conditional score 73.

Thereafter, the detection system 10 may calculate the loss for the conditional score 73 using a predefined loss function and may update the weight parameters of the score predictor 61 based on the calculated loss. By repeating these steps for other normal data segments, the score predictor 61 may become capable of accurately predicting the conditional score (e.g., the conditional score 73) for previous time-series data.

The detection system 10 may calculate the loss for the conditional score 73 based on, for example, Equations 2 and 3 below. Equations 2 and Equation 3 are both based on a Mean Squared Error (MSE) loss function, and the values for the MSE loss function may be obtained through a denoising score matching technique. The inventors of the present disclosure have derived Equation 2 from Equation 3, and for details on this this derivation process, refer to the paper titled “Regular Time-series Generation using SGM.”

In Equations 2 and 3 below, “E” denotes an expectation, the Se term represents the conditional score (e.g., the conditional score 73) predicted by the score predictor 61, and “logp” represents the log probability density of a conditional distribution. For other notations, refer to the description of the previous equation.

$${L}_{1} ( t ) = \qquad [ Equation 2 ]$$

$${E}_{{x}_{t - w : t}^{l}} [ {‖ {S}_{θ} ( {x}_{t - w : t}^{l} , {x}_{t - w : t - 1}^{0} , l ) - {∇}_{{x}_{t - w : t}^{l}} log p ( {x}_{t - w : t}^{l} \vert {x}_{t - w : t}^{0} ) ‖}_{2}^{2} ]$$

$${E}_{{x}_{t - w : t}^{l}} [ {‖ {S}_{θ} ( {x}_{t - w : t}^{l} , {x}_{t - w : t - 1}^{0} , l ) - {∇}_{{x}_{t - w : t}^{l}} log p ( {x}_{t - w : t}^{l} \vert {x}_{t - w : t - 1}^{0} ) ‖}_{2}^{2} ] \qquad [ Equation 3 ]$$

Equations 2 and 3 may be understood as being modifications of the loss function used in the forward process for training the score predictor 61, tailored to fit time-series data by reflecting the relationship with samples for previous times. The inventors of the present disclosure have derived Equations 2 and 3 by replacing the predicted score-related term in an existing loss function with the conditional score-related term for previous time-series data, and transforming the variable x in the existing loss function into a variable (e.g., x_{t-w:t}) suitable for time-series data (i.e., data segments).

Referring back to FIG. 4, in step S42, data for a specific time (e.g., the time t) and data segments corresponding to a previous period before the specific time (e.g., time-series data for a period of time followed by the time t) from target time-series data. Here, the target time-series data may denote time-series data to be subjected for anomaly detection.

For example, the detection system 10 may extract data segments (e.g., time-series data before the time t) from the target time-series data using a sliding window technique, and may divide the extracted data segments into data for a most recent time (e.g., the time t) and other data segments.

In step S43, the trained score predictor may predict a conditional score for the extracted data segments (e.g., the time-series data before the time t), and may conduct an anomaly determination for the data for the specific time (e.g., the time t) using the predicted conditional score. The anomaly determination may be conducted in various manners.

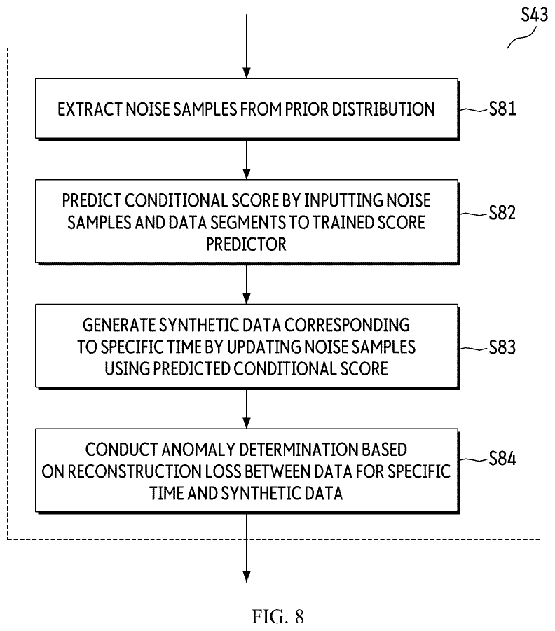

Specifically, in some embodiments, synthetic data corresponding to the specific time may be generated using the predicted conditional score. Then, an anomaly determination may be conducted based on a reconstruction loss between the original data for the specific time and the generated synthetic data. That is, the reconstruction loss may be used as an anomaly score, and this will be described later with reference to FIGS. 8 through 10.

Alternatively, in some embodiments, an Ordinary Differential Equation (ODE) corresponding to a reverse SDE used in the synthetic data generation process may be determined, and the conditional probability of the data for the specific time for the extracted data segments may be calculated using the ODE. The reverse SDE, which is an equation using the predicted conditional score as a coefficient, is as indicated by Equation 7 below, and the ODE is as indicated by Equation 4 below. In this case, an anomaly determination may be conducted based on the predicted conditional probability (i.e., using the predicted conditional probability as an anomaly score, as indicated by Equation 5 below). For example, if the predicted conditional probability is less than a threshold, the detection system 10 may determine the data for the specific time as being abnormal because a low conditional probability for previous time-series data suggests that the data for the specific time has different characteristics from the previous time-series data. The existence of a matching ODE for an SDE and the calculation of a conditional probability using an ODE are already well known to one of ordinary skill in the art to which the present disclosure pertains, and thus, detailed descriptions thereof will be omitted. For more information, see the paper titled “Score-Based Generative Modeling through Stochastic Differential Equations.”

In Equation 5 below, A_{prob}(t) represents the anomaly score for data for the time t based on the conditional probability from the ODE, and the minus sign may be understood as ensuring that lower conditional probabilities result in higher anomaly scores.

$${dx}_{t - w : t}^{l} = [ f \vert ( {x}_{t - w : t}^{l} , l ) - \frac{1}{2} {g}^{2} ( l ) {∇}_{{x}_{t - w : t}^{l}} log p ( {x}_{t - w : t}^{l} {x}_{t - w : t - 1}^{0} ) ] dl \qquad [ Equation 4 ]$$

$${A}_{prob} ( t ) = - log p ( {x}_{t} \vert {x}_{t - w : t - 1} ) \qquad [ Equation 5 ]$$

Alternatively, in some embodiments, an anomaly determination for the data for the specific time may be conducted based on the magnitude of the predicted conditional score. That is, the magnitude of the predicted conditional score may be utilized as an anomaly score. For example, if the magnitude of the predicted conditional score is less than or equal to a threshold, the detection system 10 may determine the data for the specific time as being normal because normal data is expected to be located in a densely populated area of the data space and thus the magnitude of its conditional score (e.g., the magnitude of its gradient vector) may be relatively small. The magnitude of the predicted conditional score may be calculated by Equation 6 below.

In Equation 6, A_{grad(t)} denotes the anomaly score for the data for the time t, calculated based on the magnitude of the predicted conditional score (e.g., vector norm). Equation 6 assumes that the predicted conditional score is the conditional score of the first data segments (i.e., time-series data x_{t-w:t} including the data for the time t) for the second data segments (i.e., time-series data x_{t-w:t-1} corresponding to the period of time before the time t).

$${A}_{grad} ( t ) = ‖ {∇}_{{x}_{t - w : t}} log p ( {x}_{t - w : t} \vert {x}_{t - w : t - 1} ) ‖ \qquad [ Equation 6 ]$$

Alternatively, in some embodiments, a predicted loss for the predicted conditional score may be calculated using the same loss function used for training the score predictor 61. Then, an anomaly determination for the data for the specific time may be conducted based on the calculated loss. That is, the predicted loss for the predicted conditional score may be used as an anomaly score. For example, the detection system 10 may calculate the predicted loss for the predicted conditional score using Equations 2 and 3. Then, if the predicted loss exceeds a threshold, the detection system 10 may determine the data for the specific time as being abnormal, because the score predictor 61 has been trained on normal time-series data and is thus highly likely to produce a low loss for normal input data.

Alternatively, in some embodiments, an anomaly determination for the data for the specific time may be conducted using various combinations of the aforementioned examples. For example, the detection system 10 may calculate a final anomaly score by combining individual anomaly scores calculated according to the aforementioned examples in various manners (e.g., addition, multiplication, or averaging). Then, an anomaly determination for the data for the specific time may be conducted based on the final anomaly score.

It will hereinafter be described how to conduct an anomaly determination based on a reconstruction loss with reference to FIGS. 8 through 10.

FIG. 8 is an exemplary flowchart illustrating how to conduct an anomaly determination based on a reconstruction loss according to some embodiments of the present disclosure. However, the embodiment of FIG. 8 is merely exemplary for achieving the objectives of the present disclosure, and some steps may be added or omitted, as necessary.

Referring to FIG. 8, the reconstruction loss-based anomaly detection method may begin with step S81, which extracts noise samples from a prior distribution (e.g., a normal distribution). For example, the detection system 10 may extract noise samples of the same size as the window 52 of FIG. 5 from the prior distribution.

In steps S82 and S83, a conditional score may be predicted by inputting the extracted noise samples and the extracted data segments from step S42 to the trained score predictor. Then, synthetic data corresponding to the specific time (e.g., the time t) may be generated by updating the extracted noise samples with the predicted conditional score.

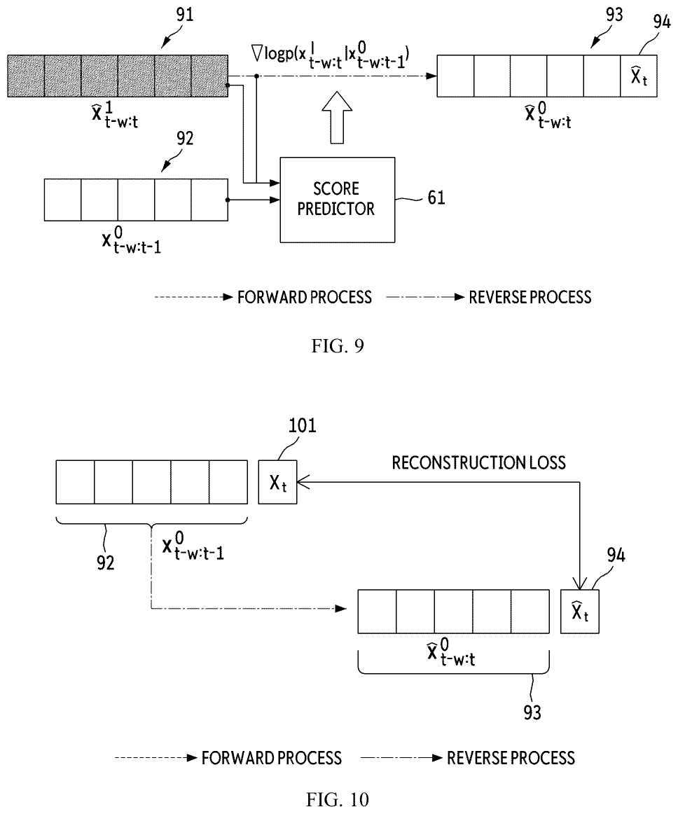

For example, referring to FIG. 9, the detection system 10 may predict a conditional score by inputting data segments 92 (e.g., the time-series data before the time t) extracted from target time-series data and noise samples 91 to the trained score predictor 61. Then, the detection system 10 may generate synthetic data segments 93 by gradually updating the noise samples 91 with the predicted conditional score (i.e., removing noise from the noise samples 91. As illustrated in FIGS. 9 and 10, synthetic data 94 for the specific time may be obtained from the synthetic data segments 93.

Steps S82 and S83 may be understood as corresponding to the reverse process and being repeated as many times as the maximum number of time steps.

The reverse process may be performed based on the reverse SDE indicated by Equation 7. In Equation 7, the “logp” term denotes a conditional score. The detection system 10 may complete the reverse SDE below by substituting the conditional score produced by the score predictor 61, and may generate the synthetic data segments 94 by solving the reverse SDE using the predictor-corrector method. Here, the term “predictor” refers to finding the solution of the reverse SDE by updating the noise samples 91 (i.e., removing noise from the noise samples 91) using a solver, and the term “corrector” refers to correcting the updated noise samples 91 using a score-based MCMC technique.

$${dx}_{t - w : t}^{l} = \qquad [ Equation 7 ]$$

$$[ f \vert ( {x}_{t - w : t}^{l} , l ) - {g}^{2} ( l ) {∇}_{{x}_{t - w : t}^{l}} log p ( {x}_{t - w : t}^{l} {x}_{t - w : t - 1}^{0} ) ] dl + g ( l ) dw$$

For further details on the reverse SDE indicated by Equation 7, refer to the paper titled “Score-Based Generative Modeling through Stochastic Differential Equations.”

Referring back to FIG. 8, in step S84, an anomaly determination may be conducted based on the reconstruction loss between the data for the specific time (e.g., the time t) and the corresponding synthetic data. That is, the reconstruction loss may be utilized as an anomaly score. For example, as illustrated in FIG. 10, the detection system 10 may generate synthetic data 94 corresponding to the specific time and may calculate the reconstruction loss between the synthetic data 94 and data 101, which is the data for the specific time, as indicated by Equation 8 below. If the reconstruction loss exceeds a threshold, the detection system 10 may determine the data 101 as being abnormal because poor restoration of the data for the specific time means that the data for the specific time bears more of the characteristics of abnormal data.

In Equation 8, A_{recon}(t) represents the reconstruction loss and the anomaly score for the data for the time t.

$${A}_{recon} ( t ) = {‖ {\hat{x}}_{t} - {x}_{t} ‖}_{2}^{2} \qquad [ Equation 8 ]$$

Meanwhile, in some embodiments, the detection system 10 may generate a plurality of synthetic data corresponding to the specific time by extracting a plurality of noise samples from the prior distribution. The detection system 10 may aggregate reconstruction losses for the plurality of synthetic data. Then, if the aggregated reconstruction loss exceeds a threshold, the detection system 10 may determine the data for the specific time as being abnormal. This approach may be understood as mitigating the variability of the reconstruction losses depending on the noise samples. For example, the detection system 10 may aggregate the reconstruction losses using Equation 9 below. In this manner, as the final reconstruction loss can be stably calculated, the accuracy of anomaly detection can be enhanced.

In Equation 9, “n” denotes the number of noise samples (or synthetic data).

$${A}_{recon} ( t ) = {‖ \frac{1}{n} {\sum }_{i = 1}^{n} {\hat{x}}_{t , i} - {x}_{t} ‖}_{2}^{2} \qquad [ Equation 9 ]$$

The anomaly detection method according to some embodiments of the present disclosure has been described so far with reference to FIGS. 4 through 10. According to the embodiments of FIGS. 4 through 10, anomalies can be detected in target time-series data using a score predictor trained on normal time-series data, without the need for abnormal time-series data. Therefore, the cost involved in acquiring abnormal time-series data can be considerably reduced.

Moreover, by configuring the score predictor to predict a conditional score based on previous time-series data, the performance of the score predictor and the quality of synthetic time-series data can be significantly enhanced. That is, by designing and training the score predictor to take into consideration the characteristics of time-series data (e.g., the relationship with data for previous points in time), the performance of the score predictor can be significantly improved. As the quality of the synthetic time-series data is improved, the accuracy of anomaly detection can also be enhanced. For example, since the accuracy of anomaly detection based on a reconstruction loss depends on the quality of the synthetic time-series data, the creation of high-quality synthetic time-series data (e.g., synthetic data for a specific time) can also improve the accuracy of anomaly detection.

In addition, by utilizing not only a reconstruction loss, but also a conditional score, a conditional probability, the magnitude of the conditional score, and a loss associated with the conditional score as an anomaly score, the accuracy of anomaly detection for time-series data can be further improved.

An anomaly detection method according to some embodiments of the present disclosure will hereinafter be described with reference to FIGS. 11 through 15. For clarity, descriptions of content that overlaps with the previous embodiments will be omitted.

FIG. 11 is an exemplary flowchart illustrating an anomaly detection method according to some embodiments of the present disclosure. However, the embodiment of FIG. 11 is merely exemplary for achieving the objectives of the present disclosure, and some steps may be added or omitted, as necessary.

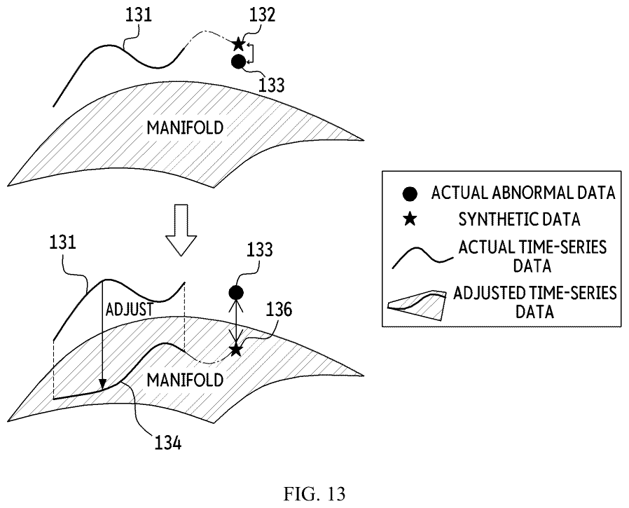

The embodiment of FIG. 11 relates to a method that can further improve the accuracy of anomaly detection by adjusting data segments, used for an anomaly determination for data for a specific time (e.g., a time t), to be closer to normal data. For the rationale behind the adjustment of the data segments, refer to the content described in FIG. 13.

Referring to FIG. 11, in step S111, the score predictor may be trained using normal time-series data. For example, the detection system 10 may train the score predictor 61 by performing a forward process on a plurality of data segments extracted from the normal time-series data. The loss function (hereinafter, the first loss function) indicated by Equations 2 and 3 may be used for training the score predictor 61. The first loss function may refer to a loss function for a conditional score as previously discussed.

In some embodiments, the score predictor may also be trained based further on a second loss function, which is for a general score that does not condition on previous time-series data, and this will hereinafter be described in detail with reference to FIG. 12.

Referring to FIG. 12, the detection system 10 may train the score predictor 61 using two sets of extracted data segments (121 and 122) from the normal time-series data 123. In this case, the first loss function may be used (for more information, refer to the content described in FIG. 7).

Additionally, the detection system 10 may further train the score predictor 61 by performing an appropriate padding on data segments 122 to produce padded data segments 124 and conducting the forward process on the padded data segments 124. In this case, the second loss function may be used.

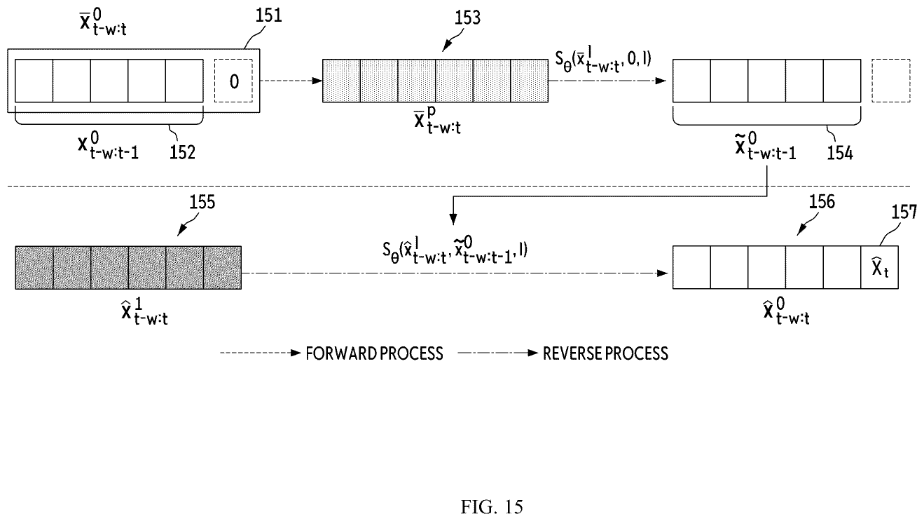

Specifically, the detection system 10 may add noise to the padded data segments 124 to create multiple noisy data segments 125, may predict the score (i.e., general score) of the noisy data segments 125 through the score predictor 61, and may calculate the loss for the predicted score using the second loss function. Then, the detection system 10 may update the weight parameters of the score predictor 61 based on the calculated loss. Here, the further training of the score predictor 61 using the second loss function may be understood as being for improving the performance of data segment adjustment (refer to FIG. 15 for the use of the general score on noise data segments 153).

The second loss function may be defined by, for example, Equation 10 below. For notations in Equation 10, refer to the descriptions of the previous equations.

$${L}_{2} ( t ) = {E}_{{\overline{x}}_{t - w : t}^{l}} [ {‖ {S}_{θ} ( {\overline{x}}_{t - w : t}^{l} , 0 , l ) - {∇}_{{\overline{x}}_{t - w : t}^{l}} log p ( {\overline{x}}_{t - w : t}^{l} \vert {\overline{x}}_{t - w : t}^{0} ) ‖}_{2}^{2} ] \qquad [ Equation 10 ]$$

FIG. 12 illustrates that a zero padding is performed to match the size of data segments to the score predictor 61. Also, in FIG. 12, the symbol-above “x” indicates that data x has been padded.

Referring back to FIG. 11, in step S112, the data for the specific time (e.g., the time t) and first data segments corresponding to a previous period before the specific time (e.g., time-series data before the time t) can be extracted from the target time-series data. For more details on step S112, please refer to the description of step S42.

In step S113, the trained score predictor may adjust the first data segments to be closer to normal data, thereby creating second data segments. The first data segments may refer to data segments yet to be adjusted, and the second data segments may refer to adjusted data segments. Step S113 will hereinafter be described with reference to FIGS. 13 through 15.

FIG. 13 is an exemplary conceptual diagram for explaining the reasons for adjusting data segments. Specifically, FIG. 13 compares actual time-series data and adjusted time-series data on the manifold of normal data.

Referring to the upper part of FIG. 13, abnormal data occurs consecutively in actual time-series data, with many instances frequently found concentrated in certain areas. The score predictor 61 may generate synthetic data with similar characteristics to previous time-series data. Therefore, if there are many abnormal data in previous time-series data 131, plausible abnormal data 132 may be generated by the score predictor 61. In this case, the difference (e.g., reconstruction loss) between the generated abnormal data 132 and actual abnormal data 133 may not be significant, leading to a reduced accuracy in anomaly detection.

To address this issue, the detection system 10 may adjust the previous time-series data 131 to be closer to normal data and may perform abnormal detection using adjusted previous time-series data 134. For example, the detection system 10 may generate synthetic data 136 for the specific time using the adjusted previous time-series data 134, thereby calculating a reconstruction loss. In this case, as illustrated in the lower part of FIG. 13, the difference between the synthetic data 136 and the actual abnormal data 133 becomes more significant, which can substantially improve the accuracy of anomaly detection.

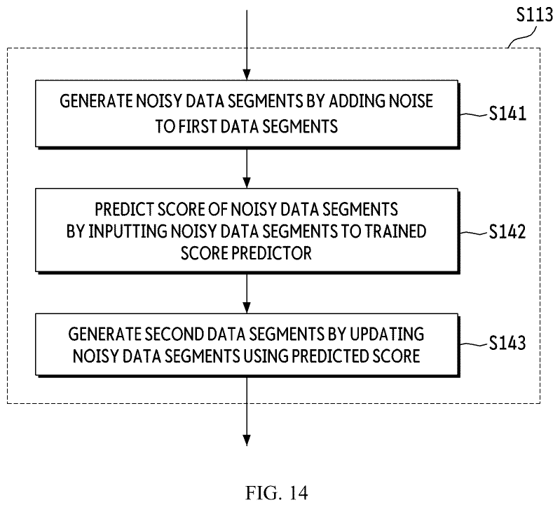

The adjustment of the first data segments corresponding to the previous time-series data 131, i.e., step S113, is performed as illustrated in FIG. 14.

Referring to FIG. 14, the detection system 10 may generate noise data segments (S141) by adding noise to the first data segments to dilute the characteristics of the first data segments, and may then update the noise data segments through the trained score predictor 61, i.e., using a general score, rather than a conditional score (S142 and S143). Here, the addition of noise may be understood as being the forward process, and the update of the noise data segments may be understood as being the reverse process.

For example, referring to FIG. 15, the detection system 10 may perform padding on first data segments 152 to produce padded first data segments 151, may perform the forward process to produce noise data segments 153, and may perform the reverse process to produce second data segments 154. In FIG. 15, the symbol ˜ above “x” denotes that data x has been adjusted, and “p” denotes a parameter corresponding to the amount of noise added as a time step in the forward process.

In step S141, an appropriate amount of noise may preferably be added because the addition of too much noise may completely erase the original characteristics of the first data segments. The amount of noise to be added (e.g., the number of time steps to be repeated in the forward process, denoted by “p”) may be set by a hyper-parameter and may be experimentally determined, but the present disclosure is not limited thereto.

Referring back to FIG. 11, in step S114, the trained score predictor may predict a conditional score for the second data segments (e.g., adjusted time-series data for the period before the time t) and may conduct an anomaly determination for the data for the specific time (e.g., the time t) using the predicted conditional score. Step S114 may be performed in various manners.

Specifically, in some embodiments, as illustrated in FIG. 15, synthetic data 157 corresponding to the specific time (e.g., the time t) may be generated using the conditional score of noise samples 155 for second data segments 154. Then, an anomaly determination may be conducted based on the reconstruction loss between the data for the specific time (i.e., the original data) and the synthetic data 157. For more details, refer to the descriptions of the previous embodiments.

Alternatively, in some embodiments, an anomaly determination for the data for the specific time may be conducted based on a conditional probability from an ODE corresponding to the reverse SDE used in the generation of synthetic data.

Alternatively, in some embodiments, an anomaly determination for the data for the specific time may be conducted based on the magnitude of the predicted conditional score.

Alternatively, in some embodiments, an anomaly determination for the data for the specific time may be performed using the first loss function and/or the second loss function used in training the score predictor. For example, the detection system 10 may perform an anomaly determination based on various combinations of a first predicted loss for the conditional score calculated by the first loss function and a second predicted loss for the general score calculated by the second loss function.

Alternatively, in some embodiments, an anomaly determination for the data for the specific time may be conducted based on various combinations of the aforementioned embodiments.

The anomaly detection method according to some embodiments of the present disclosure has been described so far with reference to FIGS. 11 through 15. According to the embodiment of FIGS. 11 through 15, the accuracy of anomaly detection can be further improved by adjusting time-series data for a period before a specific time to be closer to normal data and performing an anomaly determination for data for the specific time using a conditional score for the adjusted time-series data.

Meanwhile, the anomaly detection methods that have been explained thus far can be applied to general sequence data without any substantial change in the technical concept of the present disclosure. For example, the detection system 10 may perform an anomaly detection for specific sequence data that is not necessarily time-series data, using the aforementioned anomaly detection methods.

An exemplary computing device that can implement the detection system 10 will hereinafter be described with reference to FIG. 16.

FIG. 16 is an exemplary hardware configuration view of a computing device 160.

Referring to FIG. 16, the computing device 160 may include at least one processor 161, a bus 163, a communication interface 164, a memory 162, which loads a computer program 166 executed by the processor 161, and a storage 165, which stores the computer program 166. FIG. 16 illustrates only components related to the embodiments of the present disclosure, and it is obvious to one of ordinary skill in the art to which the present disclosure pertains that other general-purpose components than those illustrated in FIG. 16 may also be included in computing device 160. In some embodiments, the computing device 160 may be configured without some of the components illustrated in FIG. 16. Each of the components of the computing device 160 will hereinafter be described.

The processor 161 may control the overall operations of the components of the computing device 160. The processor 161 may be configured to include at least one of a Central Processing Unit (CPU), a Micro Processor Unit (MPU), a Micro Controller Unit (MCU), a Graphics Processing Unit (GPU), and any other form of processor well-known in the field of the present disclosure. Moreover, the processor 161 may perform computations for at least one application or program to execute operations/methods according to some embodiments of the present disclosure. The computing device 160 may be equipped with one or more processors 161.

The memory 162 may store various data, commands, and/or information. The memory 162 may load the computer program 166 from the storage 165 to execute the operations/methods according to some embodiments of the present disclosure. The memory 162 may be implemented as a volatile memory such as a random-access memory (RAM), but the present disclosure is not limited thereto.

The bus 163 may provide communication functions between the components of the computing device 160. The bus 163 may be implemented in various forms, such as an address bus, a data bus, or a control bus.

The communication interface 164 may support wired or wireless Internet communications for the computing device 160. Moreover, the communication interface 164 may support various other communication methods than the Internet communication method. For this, the communication interface 164 may be configured to include a well-known communication module in the field of the present disclosure. In some embodiments, the communication interface 164 may be omitted.

The storage 165 can non-transiently store one or more computer programs 166. The storage 165 may be configured to include a non-volatile memory such as a Read-Only Memory (ROM), an Erasable Programmable ROM (EPROM), an Electrically Erasable Programmable ROM (EEPROM), a flash memory, a hard disk, a removable disk, or any form of computer-readable recording medium well known in the technical field of the present disclosure.

The computer program 166 may include one or more instructions that, when loaded into the memory 162, cause the processor 161 to perform the operations/methods according to some embodiments of the present disclosure. That is, by executing the instructions loaded into the memory 162, the processor 161 may perform the operations/methods according to some embodiments of the present disclosure.

For example, the computer program 166 may include instructions for performing the operations of: acquiring a score predictor trained using normal time-series data; extracting data for a specific time and data segments corresponding to a previous period before the specific time from target time-series data; predicting a conditional score for the data segments through the trained score predictor; and conducting an anomaly determination for the data for the specific time using the predicted conditional score. In this case, the detection system 10 may be implemented via the computing device 160.

As another example, the computer program 166 may include instructions for performing the operations of: acquiring a score predictor trained using normal time-series data; extracting first data segments corresponding to a previous period before a specific time from target time-series data, adjusting the first data segments through the trained score predictor to create second data segments; predicting a conditional score for the second data segments through the trained score predictor; and conducting an anomaly determination for data for the specific time using the predicted conditional score. Even in this case, the detection system 10 may be implemented via the computing device 160.

As yet another example, the computer program 166 may include instructions for performing at least some of the operations/steps described above with reference to FIGS. 1 through 15. Even in this case, the detection system 10 may be implemented via the computing device 160.

Meanwhile, in some embodiments, the computing device 160 of FIG. 16 may represent a virtual machine implemented based on cloud technology. For example, the computing device 160 may be a virtual machine operating on one or more physical servers included in a server farm. In this case, at least some of the processor 161, the memory 162, and the storage 165 may be implemented as virtual hardware, and the communication interface 164 may be implemented as a virtualized networking element, such as a virtual switch.

The computing device 160 that can implement the detection system 10 has been described so far with reference to FIG. 16.

Embodiments of the present disclosure have been described above with reference to FIGS. 1 through 16, but it should be noted that the effects of the present disclosure are not limited to those described above, and other effects of the present disclosure should be apparent from the following description.

The technical features of the present disclosure described so far may be embodied as computer readable codes on a computer readable medium. The computer program recorded on the computer readable medium may be transmitted to other computing device via a network such as internet and installed in the other computing device, thereby being used in the other computing device.

Although operations are shown in a specific order in the drawings, it should not be understood that desired results may be obtained when the operations must be performed in the specific order or sequential order or when all of the operations must be performed. In certain situations, multitasking and parallel processing may be advantageous. In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

The protection scope of the present invention should be interpreted by the following claims, and all technical ideas within the equivalent range should be interpreted as being included in the scope of the technical ideas defined by the present disclosure.

What is claimed is:

1. An anomaly detection method performed by at least one computing device, comprising:
acquiring a score predictor trained using normal time-series data, wherein the score predictor is a deep learning model configured to output a conditional score for previous time-series data and the conditional score represents a gradient of data density;
extracting data for a specific time and data segments corresponding to a period before the specific time from target time-series data; and
predicting a conditional score for the data segments through the trained score predictor and conducting an anomaly determination for the data for the specific time using the predicted conditional score.

2. The anomaly detection method of claim 1, wherein the score predictor includes a convolution layer that performs a one-dimensional (1D) convolution operation.

3. The anomaly detection method of claim 1, wherein the score predictor is configured based on a neural network with a U-Net architecture.

4. The anomaly detection method of claim 1, wherein the conducting the anomaly determination for the data for the specific time, comprises: extracting noise samples from a prior distribution; predicting a conditional score of the noise samples for the data segments by inputting the noise samples and the data segments to the trained score predictor; generating synthetic data corresponding to the specific time by updating the noise samples using the predicted conditional score; and determining the data for the specific time as being abnormal when a reconstruction loss between the data for the specific time and the synthetic data exceeds a threshold.

5. The anomaly detection method of claim 4, wherein
a plurality of synthetic data are generated from different noise samples extracted from the prior distribution, and
the determining the data for the specific time as being abnormal, comprises: aggregating reconstruction losses for the plurality of synthetic data; and determining the data for the specific time as being abnormal when the aggregated reconstruction loss exceeds the threshold.

6. The anomaly detection method of claim 1, wherein the conducting the anomaly determination for the data for the specific time, comprises: determining an Ordinary Differential Equation (ODE) corresponding to a Stochastic Differential Equation (SDE) used in a synthetic data generation process, wherein the SDE is an equation using the predicted conditional score as a coefficient; calculating a conditional probability of the data for the specific time for the data segments using the ODE; and determining the data for the specific time as being abnormal when the calculated conditional probability is less than a threshold.

7. The anomaly detection method of claim 1, wherein the conducting the anomaly determination for the data for the specific time, comprises determining the data for the specific time as being normal when a magnitude of the predicted conditional score is less than or equal to a threshold.

8. The anomaly detection method of claim 1, wherein the conducting the anomaly determination for the data for the specific time, comprises: calculating a loss for the predicted conditional score using a loss function used in training the score predictor; and determining the data for the specific time as being abnormal when the calculated loss exceeds a threshold.

9. An anomaly detection method performed by at least one computing device, comprising:
acquiring a score predictor trained using normal time-series data, wherein the score predictor is a deep learning model configured to output a conditional score for previous time-series data and the conditional score represents a gradient of data density;
extracting data for a specific time and first data segments corresponding to a period before the specific time from target time-series data;
generating second data segments by adjusting the first data segments through the trained score predictor; and
predicting a conditional score for the second data segments through the trained score predictor and conducting an anomaly determination for the data for the specific time using the predicted conditional score.

10. The anomaly detection method of claim 9, wherein the generating the second data segments, comprises: generating noisy data segments by adding noise to the first data segments; predicting a score of the noisy data segments by inputting the noisy data segments to the trained score predictor; and generating the second data segments by updating the noisy data segments using the predicted score.

11. The anomaly detection method of claim 10, wherein
the score predictor is trained using a first loss function related to the conditional score for the previous time-series data and a second loss function related to a general score that does not condition on the previous time-series data, and
the predicted score is a general score calculated in a state where previous time-series data of the noisy data segments is not input to the trained score predictor.

12. The anomaly detection method of claim 9, wherein the conducting the anomaly determination for the data for the specific time, comprises: extracting noise samples from a prior distribution; predicting a conditional score of the noise samples for the second data segments by inputting the noise samples and the second data segments to the trained score predictor; generating synthetic data corresponding to the specific time by updating the noise samples using the predicted conditional score; and determining the data for the specific time as being abnormal when a reconstruction loss between the data for the specific time and the synthetic data exceeds a threshold.

13. The anomaly detection method of claim 9, wherein the conducting the anomaly determination for the data for the specific time, comprises: determining an Ordinary Differential Equation (ODE) corresponding to a Stochastic Differential Equation (SDE) used in a synthetic data generation process, wherein the SDE is an equation using the predicted conditional score as a coefficient; calculating a conditional probability of the data for the specific time for the second data segments using the ODE; and determining the data for the specific time as being abnormal when the calculated conditional probability is less than a threshold.

14. The anomaly detection method of claim 9, wherein the conducting the anomaly determination for the data for the specific time, comprises determining the data for the specific time as being normal when a magnitude of the predicted conditional score is less than or equal to a threshold.

15. The anomaly detection method of claim 9, wherein the conducting the anomaly determination for the data for the specific time, comprises calculating a loss for the predicted conditional score using a loss function used in training the score predictor, and determining the data for the specific time as being abnormal when the calculated loss exceeds a threshold.

16. An anomaly detection system comprising:
at least one processor; and
a memory storing a computer program executed by the at least one processor,
wherein the computer program includes instructions for performing operations of:
acquiring a score predictor trained using normal time-series data, wherein the score predictor is a deep learning model configured to output a conditional score for previous time-series data and the conditional score represents a gradient of data density;
extracting data for a specific time and data segments corresponding to a period before the specific time from target time-series data; and
predicting a conditional score for the data segments through the trained score predictor and conducting an anomaly determination for the data for the specific time using the predicted conditional score.
